(19) United States
(12) Patent Application Publication
(10) Pub. No.: US 2003/0062067 A1
(43) Pub. Date: Apr. 3, 2003

(54) Closed cell washer

(75) Inventors: Andrew Meyer, Cardiff by the Sea, CA (US); Robert C. Downs, La Jolla, CA (US); Mark Weselak, San Diego, CA (US); Helin Dong, Palo Alto, CA (US); James K. Mainquist, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC

(21) Appl. No.: 10/251,647

(22) Filed: Sep. 20, 2002

Related U.S. Application Data
(60) Provisional application No. 60/324,478, filed on Sep. 23, 2001.

(51) Int. Cl. B08B 9/20

(52) U.S. Cl. 134/25.4; 134/42; 134/56 R; 134/104.2; 134/105; 134/184

(57) ABSTRACT

This invention provides an apparatus and method for washing a biological chip cartridge. A washing station comprises a cartridge holder that includes at least two cartridge mounting tubes that are structured to retain the biological chip cartridge on the washing station without doors. At least one fluid source communicates with one of the mounting tubes and a waste dump communicates with another mounting tube. A fluid controller controls delivery of a fluid from the fluid source to the mounting tube.

### CROSS-REFERENCE TO RELATED APPLICATIONS

Pursuant to 35 U.S.C. § 119(e) and any other applicable statute or rule, the present application claims benefit of and priority to U.S. Ser. No. 60/324,478, entitled “CLOSED CELL WASHER,” filed Sep. 23, 2001 by Meyer et al.

### FIELD OF THE INVENTION

The present invention generally relates to devices and methods for processing closed cell devices, such as biological chips. More particularly, the invention concerns a method and apparatus to inject and remove selected fluids from a biological chip cartridge.

### BACKGROUND OF THE INVENTION

A biological chip has very large numbers of probes arrayed on a solid support, which can be smaller than a thumbnail. Suitable probes include, for example, oligonucleotides, proteins, and other molecules. The probes are arranged in arrays, with each probe assigned a specific location in the array. The chips are used to determine whether target molecules interact with any of the probes on the chip. After exposing the array to target molecules under selected test conditions, scanning devices can examine each location in the array and determine whether a target molecule has interacted with the probe at that location. Examples of biological chips include the GeneChip® probe arrays that are commercially available from Affymetrix (Santa Clara, Calif.).

Biological chip cartridges have been manufactured that contain these biological chips within an enclosed volume. A biological chip cartridge can contain hundreds of arrays and is designed to be portable from one processing device to another.

One step that must be repeated several times during the processing of these biological chip cartridges is the rinsing of the chips to remove unwanted biological material. The rinsing process can require several individual cycles, and several steps. Because a large number of cartridges are often used to conduct assays, this translates to thousands of individual rinse cycles. For processing large numbers of samples, high throughput systems are desirable. However, conventional automated processing systems only have the capability to process a few cartridges at once. This creates a bottleneck in the processing of the biological samples and delays test results, thereby decreasing the efficiency and profitability of commercial laboratories and research institutions.

Therefore, a need exists for a biological chip cartridge washer that can wash a large number of chip cartridges simultaneously and with fewer manipulations than currently available chip washers. The present invention fulfills these and other needs.

### SUMMARY OF THE INVENTION

The present invention provides an apparatus and method for washing a biological chip cartridge. A washing station comprises a cartridge holder that includes at least two cartridge mounting tubes that are structured to retain the biological chip cartridge on the washing station, e.g., without doors or a movable mounting system. At least one fluid source communicates with one of the mounting tubes and a waste dump communicates with another mounting tube. A controller such as a microprocessor, e.g., communicating with a pump, typically controls delivery of a fluid from the fluid source, e.g., one or more reservoirs, to the mounting tube.

For example, the cartridges are held onto the washing station cartridge holders using cartridge mounting tubes that frictionally engage at least two tube receiving elements, e.g., septa, o-rings, diaphragms, and membranes, located on the cartridge to secure the cartridge in the holder. The cartridge mounting tubes are typically coupled to the cartridge holder by a single fastener, e.g., to provide easy removal of the tubes, e.g., for replacement.

The washing stations of the invention typically comprise a plurality of cartridge holders, e.g., from about 1 to 32 cartridge holders. The cartridge holders typically comprise cartridges to be washed, but also optionally comprise one or more non-experimental cartridges, thereby allowing washing of fewer experimental cartridges than the number of cartridge holders on the washing station. Typically, a cartridge holder comprises two indentations arranged to permit removal and mounting of the cartridge by grasping the cartridge by a top and bottom surface. This allows removal and placement of cartridges without a movable mounting system.

Typically, the fluid source comprises two or more reservoirs, e.g., containing at least one fluid selected from the group consisting of: buffers, solvents, reagents, dissolved salts, de-ionized water, water, detergents, and antibacterial solutions. A fluid pump is typically in communication with the fluid source, e.g., providing a fluid flow rate that ranges from about 2 milliliters per minute to about 7 milliliters per minute. Various pumps are optionally used with the washing stations provided, e.g., peristaltic pumps, syringe pumps, multi-channel pumps, multi-channel peristaltic pumps, and multi-channel syringe pumps, and the like. A fluid selection valve is optionally coupled to the fluid source in communication with a controller, e.g., for selecting which buffer should be pumped through the cartridges.

Fluid filters and fluid level sensors communicating with the fluid source are also optionally included in the washing stations of the present invention. For example, fluid filters that capture all objects larger than 150 microns are optionally used. A fluid level sensor typically detects a fluid level in the fluid source.

Other features of the washing stations optionally include, but are not limited to, a fluid manifold, located between the fluid source and the cartridge mounting tubes, and an air bleed valve coupled to the fluid manifold. A flow monitor or pressure monitor is also optionally included in the station to monitor fluid pressures along the flow path. In addition, a heating system is optionally used to heat the fluid flowing into and from the cartridges and the air surrounding the cartridges and biological chips contained therein.

In another aspect, the present invention provides methods of washing an enclosed volume located within a cartridge, e.g., using the devices described above. The methods typically comprise positioning the cartridge on the cartridge mounting tubes; removing a fluid from the enclosed volume, if the enclosed volume initially contains a fluid; and introducing a wash fluid into the enclosed volume. Fluid is typically removed and introduced into the enclosed volume in a cyclic manner. For example, the wash fluid is typically introduced into the enclosed volume at least about three times, e.g., at a rate of between 2 milliliters per minute to 7 milliliters per minute, optimized so that no bubbles form in the enclosed volume.

The washing stations typically comprise a plurality of cartridge washing tubes communicating with a plurality of enclosed volumes, with each cartridge washing tube coupled to a pump channel so that an amount of fluid removed and introduced into each enclosed volume is substantially identical.

In another aspect, the present invention provides a cartridge plate comprising at least one substantially open closed cell holder that is not associated with a door. Typically, the closed cell holder comprises at least two closed cell mounting tubes, wherein the closed cell mounting tubes are coupled to the closed cell holder by a single fastener, e.g., as described above.

### BRIEF DESCRIPTION OF THE DRAWINGS

FIG. 1 is a front perspective view of a closed cell cartridge washer constructed according to the present invention.

FIG. 2 is a rear perspective view of the embodiment illustrated in FIG. 1.

FIG. 3 is a side elevation view of the embodiment illustrated in FIG. 1.

FIG. 4 is a perspective view of an alternative embodiment cartridge washer constructed in accordance with the present invention.

FIG. 5 is an elevation view of a cartridge plate illustrated in FIGS. 1 and 4.

FIG. 6 is a perspective view of the cartridge plate illustrated in FIG. 5.

FIG. 7 is an elevation view of a cartridge cavity illustrated in FIGS. 5 and 6.

FIG. 8 is a perspective view of the cartridge plate illustrated in FIG. 4.

FIG. 9 is a sectional view taken along cutting plane 9—9 in FIG. 8.

FIG. 10 is an elevation view of an operator interface used to operate the present invention.

FIG. 11 is a flowchart illustrating one method of operating a closed cell cartridge washer constructed according to the present invention.

FIG. 12 is a schematic for the fluid delivery system for a 24 channel washing station.

FIG. 13 provides a sample washing sequence for the washing stations of the invention.

FIG. 14 is a schematic illustration of a liquid-heat exchanger subassembly for use in the washing stations of the invention.

FIG. 15 is a schematic illustration of a heater system optionally used with the washing stations of the invention.

### DETAILED DESCRIPTION

The processing of a large number of biological samples requires high throughput systems. As described above, biological samples are often arrayed on a solid support or “chip,” which chip is often enclosed in what is known as a chip or cell cartridge. Processing of biological chip cartridges requires several steps and conventional apparatus are only capable of processing a small number of biological chip cartridges at one time. This creates a bottle neck in the processing of the biological samples and delays test results, thereby decreasing the efficiency and profitability of commercial laboratories and research institutions. The challenge then becomes how to increase the processing speed of biological chip cartridges.

The present invention provides an apparatus and method for processing one or more, for example up to 32, biological chip cartridges simultaneously. This greatly increases cartridge throughput in comparison to conventional systems and allows for a large number of chip assays to be conducted simultaneously. In addition, the present invention is constructed and arranged to be robust, and serviceable, thereby maximizing reliability and accuracy and minimizing down time.

For example, the washing station provided herein typically comprises only two movable parts: a pump and a buffer selection solenoid. Specifically, the washing station does not involve a movable mounting system for mounting chip cartridges on the station or a door to contain or hold each chip cartridge in the station. Instead, cartridges or closed cell devices are mounted on the washing stations provided herein by simply pushing them onto a mounting frame or cartridge holder, e.g., a holder comprising replaceable septa penetrating needles which also serve to hold the device in place. Furthermore, an operator is aided in placing the cartridges onto the holder by the mounting fixture itself. No additional mechanism is required. The lack of a movable mounting system and lack of doors provides a more robust processing station than presently available, e.g., for washing chip cartridges in a high throughput format.

In the following paragraphs, the present invention will be described in detail, e.g., by way of example with reference to the attached figures. Throughout this description, the preferred embodiment and examples shown should be considered as exemplars, rather than as limitations on the present invention. As used herein, “the present invention” refers to any one of the embodiments of the invention described herein.

I. Washing Stations For Closed Cell Cartridges

A “closed cell cartridge,” “closed cartridge” or “cartridge,” as used herein, refers to a device having an “enclosed volume,” e.g., enclosing a specific volume of gas and/or fluid. Typically, each cartridge has two access ports, e.g., penetrable septa, o-rings, or the like, that are used to add and/or remove fluid and/or gas. The cartridges typically contain biological chips. A “biological chip,” as used herein, refers to a solid support comprising a plurality of biological components, e.g., an array of DNA sequences.

The cartridges typically have an enclosed volume which is often in need of washing or rinsing, e.g., for removal of unwanted material, e.g., unbound biological components from the biological chips. The present invention provides a washing station for this purpose. A plurality of cartridges are typically placed onto a mounting plate or cartridge holder which is coupled to a fluid delivery system. The cartridge holder typically comprises a plurality of replaceable tubes, e.g., pins or needles, that penetrate the cartridges. The tubes typically affix the cartridge to the cartridge holder and allow access into the enclosed volume of the cartridges, e.g. through an inlet port and output port, for wash fluids and/or gases. The fluid delivery system delivers a fluid, e.g., a wash fluid, to the enclosed volume of the chip cartridge, e.g., via the access ports in the cartridge which are affixed to one or more mounting tubes or needles on the cartridge plate. The station provides quick and accurate washing of a plurality of cartridges, e.g., 1 to about 32 cartridges. Typically a controller, e.g., a microprocessor controller, is used to enable an operator to program a number of operating parameters, e.g., number of wash cycles, number of purge cycles and purge volume. The following description details each of these elements.

Cartridge Plate For Mounting Cartridges on the Washing Station

A typical washing station of the invention comprises a cartridge holder (also referred to herein as mounting plate or cartridge plate) operably coupled to a fluid delivery system. The cartridge holder typically comprises replaceable cartridge mounting tubes, e.g., pins, needles, or tubes, that are used to mount the cartridges on the washing station and couple one or more access ports of the cartridges to the fluid delivery system. For example, the “cartridge mounting tubes” are optionally needles, pins, or cannulae that penetrate an inlet and an outlet port, e.g., two septa, on the cartridges. The tubes typically have one or more orifice through which fluid flows and are typically blunt-ended. The tubes are also connected to a fluid reservoir and a waste dump for delivery and disposal of fluids that are used to wash the cartridges or are purged from the cartridges.

The cartridge mounting tubes are structured to retain or hold the cartridges in the cartridge holder, e.g., in one or more cavities on the cartridge holder. The cartridge mounting tubes typically provide sufficient force, e.g., frictional force, to retain the cartridges in place without the use of a door or “movable mounting system.” In addition, the cartridge mounting tubes typically retain the cartridge in place such that the access ports or “tube receiving elements” on the cartridge are aligned with or coupled to the mounting tubes, e.g., the pins or needles, thereby providing a fluid connection to provide gas or fluid delivery to the enclosed cartridge volume. Tube receiving elements used in the present invention include, but are not limited to, septa, o-rings, diaphragms, membranes, and the like.

Because the mounting tubes secure the cartridges to the cartridge holder, e.g., via the access ports, the washing stations provided herein do not require doors over the plate area. For example, in some embodiments, the cartridge plate is not associated with a door. Cartridge holders that, unlike those of this embodiment of the invention, are associated with a door, are described in U.S. Pat. No. 6,114,122 to Bessemer et al. The lack of a door provides an advantage to the present invention, in that it simplifies the loading of cartridges onto the washing station. Moreover, fewer moving parts are required, therefore simplifying manufacturing and cleaning of the washing stations and resulting in fewer parts that are susceptible to malfunction or breakage.

Another advantage of the present invention is that the cartridge holders or cartridge plates of the washing stations, in some embodiments, are not associated with a movable mounting system. Movable mounting systems, e.g., of the type not present in these embodiments, are described in, for example, U.S. Pat. No. 6,114,122. Again, the lack of a movable mounting system simplifies manufacturing and reduces the number of parts that are susceptible to breakage or malfunction. In some embodiments, the cartridge holders both lack a door and are not associated with a movable mounting system.

Instead of a movable mounting system, e.g., to position and secure the cartridges in the cartridge holder, the present invention provides a system wherein the cartridge holder itself is used as a guide to position the cartridges thereon. For example, in some embodiments, the cartridge holder comprises a plurality of cavities, e.g., 1 to about 32 or more cavities. Each cavity is configured to receive a cartridge of the invention. In addition to the cavities, the cartridge holder comprises a series of indentations or reliefs in each cavity to guide placement of the cartridge into and out of the cavity. An operator optionally places one or two fingers into the indentations to guide the cartridge into the desired cavity. By simply pushing the cartridge into the cavity and onto the mounting tubes, the cartridge is secured on the holder and ready for washing. A movable mounting mechanism is not necessary.

An additional feature that adds to the efficiency of the present devices is the mounting system used to mount and replace the cartridge mounting tubes on the cartridge holder. This system allows clogged needles to be replaced easily and quickly. As many high salt buffers are used in biological assays and applications, the cartridge mounting tubes can become clogged rather easily. This is overcome in the present invention by the use of a mounting system employing a single fastener to couple the cartridge mounting tubes to the cartridge holder. The single fastener enables the needles or tubes to be quickly and easily replaced when clogged.

An additional feature used in the present invention to overcome the problem of clogged needles is that side-ported tubes or needles, e.g., needles with the opening on the side instead of the end or tip (end-ported) are provided. The side ported tubes result in less clogging, e.g., because the needle or tube does not core into the septa and become clogged with the material used to make the septa in addition to salt crystals from various buffers.

Fluid Delivery System For Washing Cartridges

Cartridge holders as described above are typically coupled to a fluid delivery system to provide a washing station. The fluid delivery system typically comprises a pump, e.g., a peristaltic pump, a syringe pump, a multi-channel pump, a multi-channel peristaltic pump, a multi-channel syringe pump, or the like, and one or more fluid sources, e.g., a reservoir comprising a buffer, solvent, water, or the like, and a waste dump or reservoir, for receiving fluids or gases that have been purged or removed from the enclosed volume of the cartridge. Additional elements of the fluid delivery system optionally include, but are not limited to, a buffer selection valve to allow the use of one or more buffer for flushing the cartridges of the invention, a buffer distribution manifold, e.g., with air bleed valves, fluid level sensors, reagent reservoirs, filters for filtering reagents prior to use, various tubing to form a fluid connection between the fluid delivery system and the cartridges in the cartridge holder, and a controller for programming wash cycles.

For example, the fluid delivery system typically connects an inlet tube and outlet tube to the access ports on the cartridge via the cartridge mounting tubes on the cartridge holder. Typical upstream or supply line tubing comprises ¼-inch ID tubing and drain line or downstream tubing is typically at least ⅜-inch ID tubing. The pump, e.g., a multichannel peristaltic pump, is used to pump fluid from a source through the inlet tubes, through the mounting tubes, and into the enclosed volume of the cartridges, e.g., through the access ports which are coupled to the mounting tubes. The wash fluid is then typically removed to the waste dump via an outlet tube.

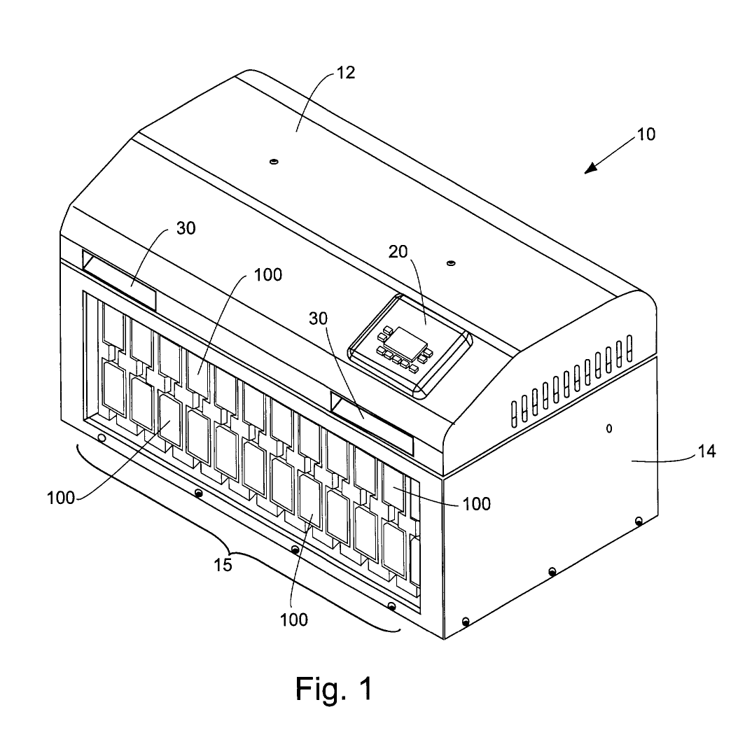

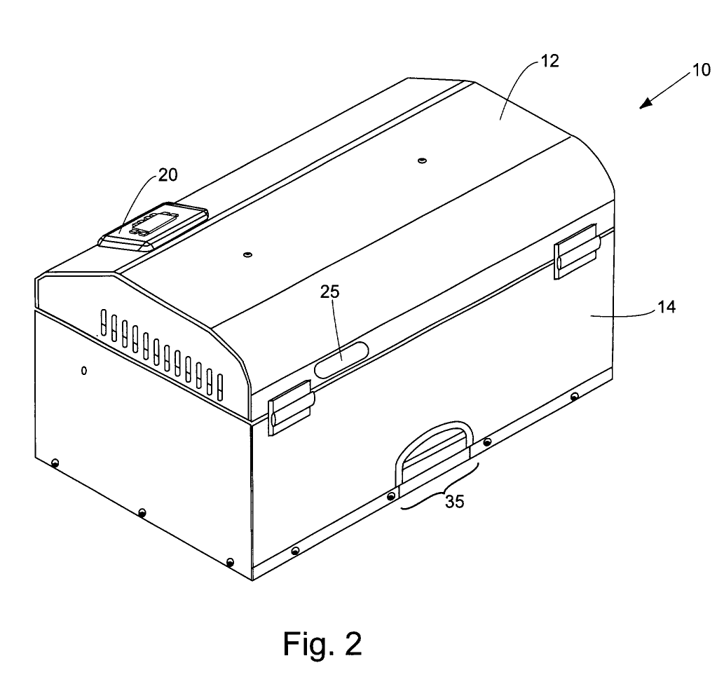

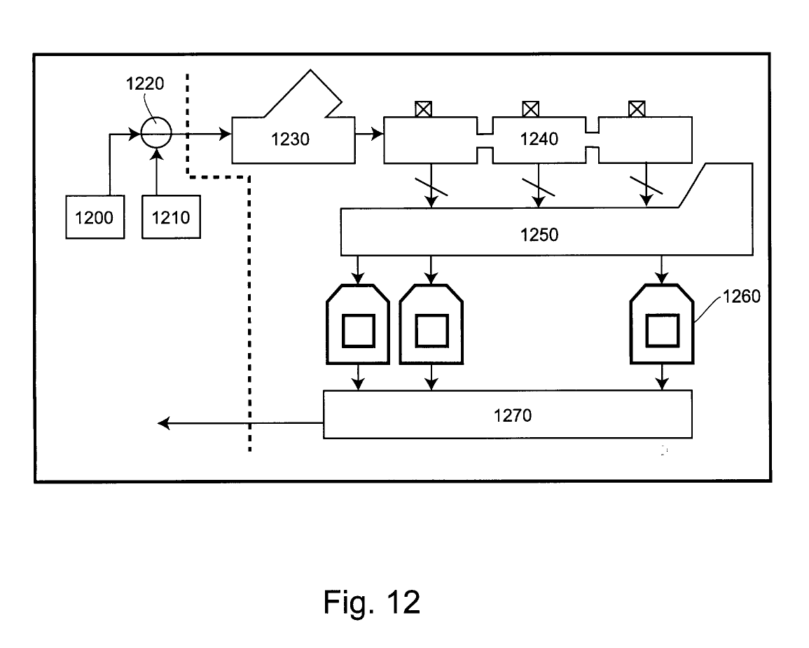

A schematic illustration of a fluid delivery system of the invention is provided in FIG. 12. The system illustrated comprises two buffer reservoirs, reservoir 1200 and 1210, and buffer selection valve 1220, typically one of only two movable parts in the system. From the buffer reservoirs, the fluid flows through filter 1230, e.g., a 100-mesh screen filter, to remove foreign objects, and then into intake manifold 1240. Typically, the buffer reservoirs are placed above the washing station to aid fluid flow from the reservoir to the manifold. Multiple manifold blocks are optionally used, e.g., two or three blocks depending on the system configuration. The manifolds are typically equipped with bleed valves, e.g., manually operated bleed valves, to remove air from the system. From the manifold, the buffer flows through pump 1250, e.g., a multichannel peristaltic pump, and into the mounting tubes, e.g., needles, pins, or cannulae, that are coupled to the cartridges during operation. From the mounting tubes, the buffer flows into the cartridges to be washed, e.g., cartridges 1260. Fluid is then pumped out of the enclosed cartridge volumes into waste manifold 1270 as pictured. The waste manifold provides a channel for the removal of fluid pumped through the cartridges and a channel through which air is introduced into the cartridges, e.g., during a drain portion of the wash cycles. In FIG. 12, the parts to the right of the dotted line are typically enclosed within the washing station, e.g., housed in a single enclosure, and the parts to the left of the dotted line are external to the system. An example station is shown in FIGS. 1 and 2, e.g., as described below.

One advantage of the present fluid delivery system is that an independent pump channel, is typically used to deliver fluid to each cartridge. A single drive unit or pump operates all of the channels simultaneously and at the same speed. This ensures that each closed cell cartridge receives the same amount of fluid from each inlet tube. In contrast, conventional devices employ a single pump channel that distributes fluid through a manifold to multiple hoses that introduce fluid to the cartridges. The fluid flow rate in a single pump channel system varies as a function of tubing constrictions and inlet tube constructions, thus delivering different amounts of fluid to different cartridges, which reduces the accuracy of the test procedure. In addition, a single peristaltic pump used with the system has the added advantage of providing a system in which fluid does not leave the tubing until it reaches the enclosed volume of the cell or cartridge.

Example Washing Stations

Referring to FIGS. 1 and 2, one embodiment of a washing station is illustrated, e.g., closed cell cartridge washer 10. This embodiment employs a housing that has lower section 14 with hinged upper section 12. Handgrips 30 are optionally provided, e.g., to allow an operator to open upper section 12, e.g., to gain access to the interior of closed cell cartridge washer 10. The front of cartridge washer 10 is substantially open thereby permitting access to cartridge plate 15. Cartridge plate 15 contains a plurality of cartridge cavities 100, which cartridge cavities are used to hold the cartridges in place on the cartridge plate, e.g., for washing. In the illustrated embodiment cartridge plate 15 has twenty-four cartridge cavities. Other embodiments optionally include up to thirty-two cartridge cavities. However, washing stations with less than or more than 32 cartridge cavities are optionally constructed according to the present invention. It will also be appreciated that an enclosure may also be provided for cartridge plate 15, such as a sliding or hinged door. However, the embodiment illustrated does not include a door, thereby providing open cavities into which cartridges are inserted and held into place without a door.

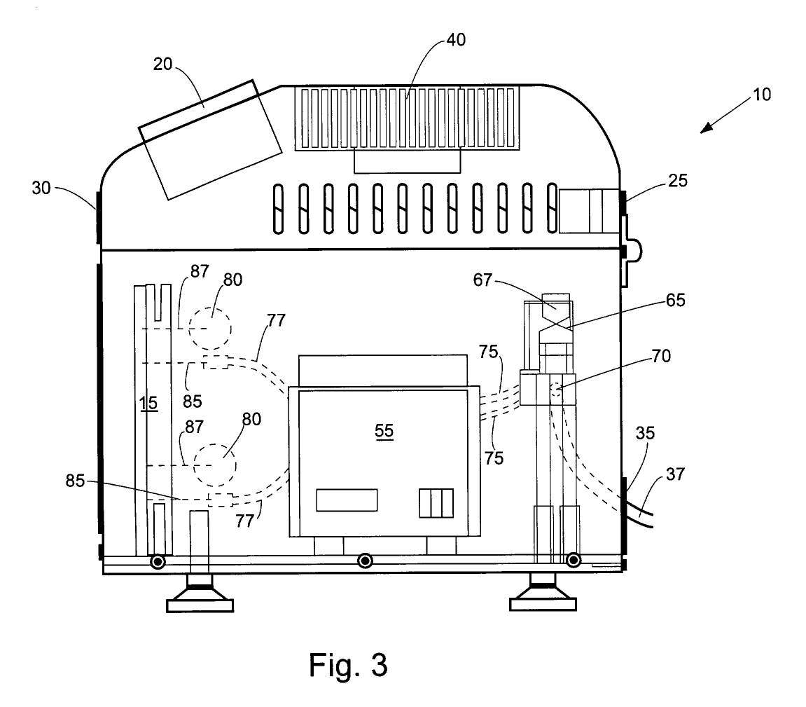

Upper section 12 of cartridge washer 10 includes operator interface 20 that communicates with programmable controller 40, e.g., as illustrated in FIG. 3. The back of cartridge washer 10 includes power port 25 that provides electricity to programmable controller 40. Also shown in FIG. 2, is pipe inlet 35 that provides access for pipes or hoses containing cleansers and other types of fluids to be used in the processing of closed cell cartridges 110. Other embodiments may place the power port, e.g., power port 25, in other locations on cartridge washer 10 and hose inlet 35 may also be located in other locations on cartridge washer 10.

FIG. 3 illustrates one possible arrangement of components within a washing station, e.g., closed cell cartridge washer 10. Pipe 37 delivers a desired fluid to fluid inlet 70 located on fluid manifold 65 that distributes the fluid through a plurality of upstream hoses 75 that are connected to pump 55. Pump 55 then pumps the fluid through downstream hoses 77 that are connected to inlet tubes 85. Inlet tubes 85 deliver fluid to closed cell cartridges 110 when the cartridges are placed within the cartridge cavities, e.g., cartridge cavities 100 in cartridge plate 15. Fluid is pumped through closed cell cartridges 110 and exits cartridges 110 through waste tube 87 that delivers the waste to waste dump 80. Waste dump 80 is connected to a waste pipe 82 that removes the waste fluid.

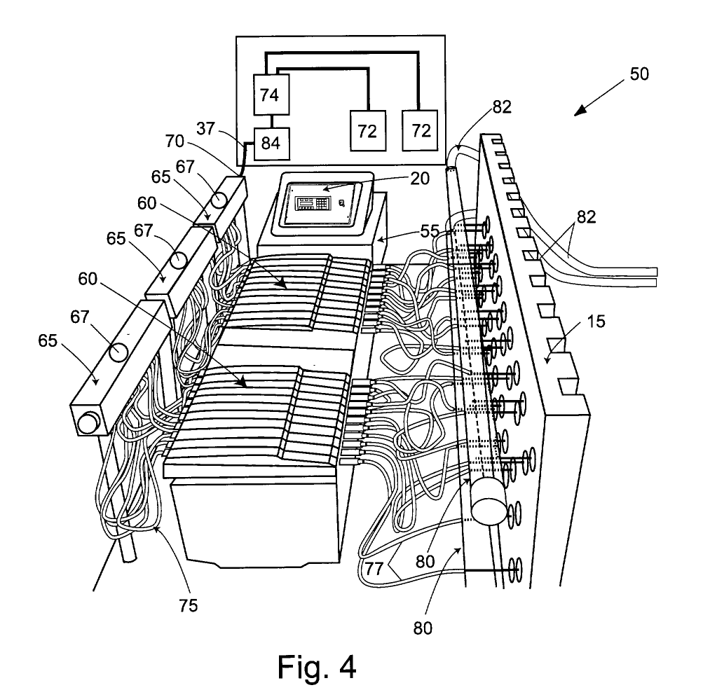

The above described components are illustrated more clearly in an alternative embodiment of a washing station, e.g., bench-top cartridge washer 50, illustrated in FIG. 4. Bench-top cartridge washer 50 is constructed in a modular fashion that permits the addition or subtraction of cartridge cavities 100, thereby allowing individual operators to construct a cartridge washer that meets their processing requirements, e.g., number of cartridges to be washed and size of individual cartridges. For example, a cartridge washer is optionally designed to wash 12 cartridges having varying enclosed volumes. As discussed above in connection with closed cell cartridge washer 10, pipe 37 delivers a desired fluid from fluid reservoir 72. The fluid reservoir may include several individual fluid sources that communicate with a fluid selection switch, e.g., switch 74. Fluid selection switch 74 is controlled by controller 40 that receives instructions from operator interface 20. In some embodiments, controller 40 is a programmable computing device that can be programmed through operator interface 20, e.g., to direct wash times and flow rates for various cartridges.

Fluid enters the washing station, and is distributed by, fluid manifold 65 into upstream hoses 75 that are connected to individual pump channels 60 that are driven by pump 55. Pump 55 is preferably a multi-channel peristaltic pump, but other types of pumps such as syringe pumps and other suitable pumps are also optionally employed. Pump 55 controls each channel, e.g., channel 60, wherein each channel is connected to an individual upstream hose 75 and downstream hose 77. Each upstream hose 75 and downstream hose 77 correspond to a specific mounting tube or needle, e.g., inlet tube 85. The individual pump channels 60 are used to deliver fluid to each inlet tube 85. A single pump, e.g., pump 55, operates all of the channels simultaneously and at the same speed. This ensures that each closed cell cartridge 110 receives the same amount of fluid from each inlet tube 85.

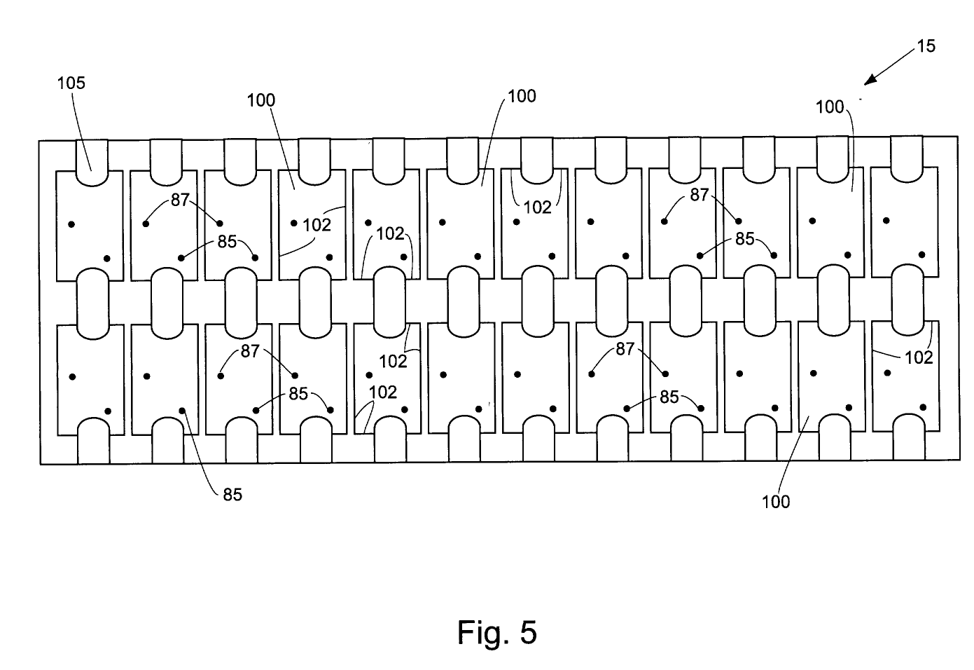

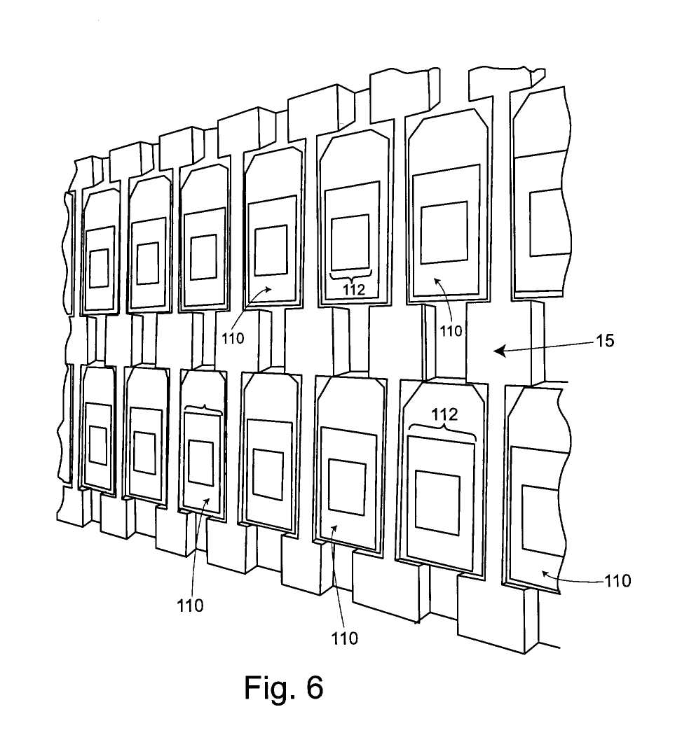

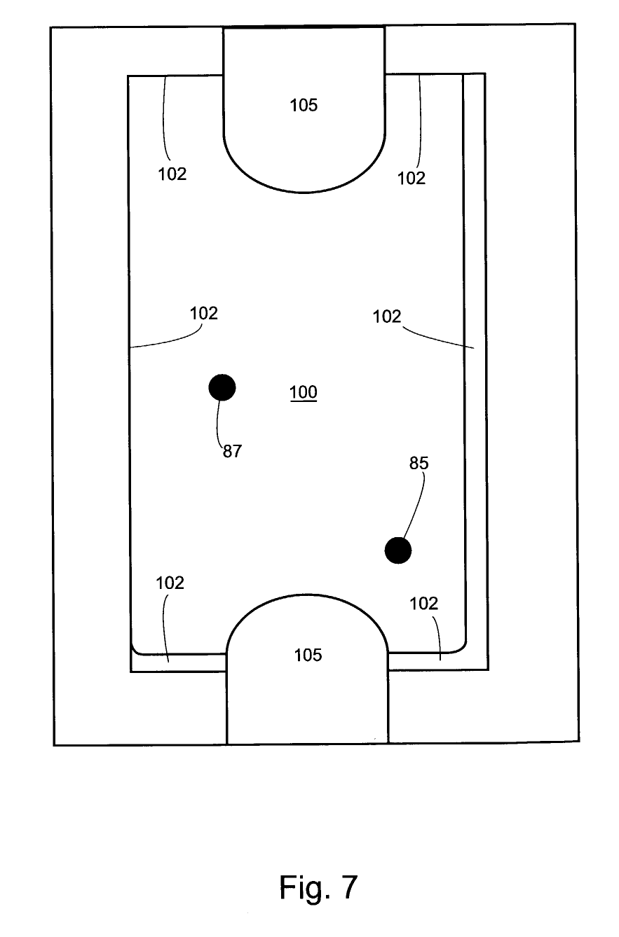

Referring now to FIGS. 5-7, cartridge plate 15 is illustrated. Cartridge plate 15 includes a plurality of cartridge cavities 100, which plurality optionally varies from one up to about thirty-two or more cartridge cavities. Preferably, twenty-four cartridge cavities are arranged in two rows, as illustrated in FIGS. 5 and 6. An alternative embodiment may employ 32 cartridge cavities, e.g., cartridge cavities 100, e.g., arranged in two or more rows. As shown in FIGS. 5 and 7, each cartridge cavity 100 includes two reliefs or indentations 105. The reliefs are located at the upper and lower areas of each cartridge cavity 100 and are sized to receive the finger tips of an operator when a closed cell cartridge is placed into the cartridge cavity. This allows an operator to easily and quickly remove a cartridge from the plate or load a cartridge onto the plate. Each cartridge cavity 100 is formed by four walls 102 that define a substantially rectangular shape. The four walls are sized and arranged so that when a closed cell cartridge is placed in a cartridge cavity, the access ports or septa on the closed cell cartridge align with both inlet tube 85 and waste tube 87.

As shown in FIG. 6, the closed cell cartridges, e.g., cartridges 110, are mounted substantially vertically in cartridge cavities 100. One aspect of the present invention is that each closed cell cartridge 110 is held in cartridge cavity 100 only by the frictional forces generated between waste tube 87 and inlet tube 85 and the septa located on closed cell cartridge 110.

Specifically, each closed cell cartridge 110 includes an enclosed volume 112 that has an inlet and an exit that allows the passage of air, fluids and biological materials. The inlet and exit on each closed cell cartridge 110 are sealed by septa, such as membranes, o-rings, or other suitable structures. As shown in FIGS. 5 and 7, each cartridge cavity 100 includes inlet tube 85 and waste tube 87. Inlet tube 85 and waste tube 87 are positioned in the cartridge cavity so that when a closed cell cartridge is placed in the cartridge cavity, the septa located on the closed cell cartridge engage the inlet tube and waste tube. Once a closed cell cartridge is mounted on inlet tube 85 and waste tube 87, the friction between tubes 85 and 87 and the septa located on the closed cell cartridge maintains the cartridge in position in the cartridge cavity. No additional supports or other securing means are necessary to keep the closed cell cartridge in place in the cartridge cavity. This has several advantages, including the ability to quickly mount and dismount closed cell cartridges from the cartridge cavities. This feature also eliminates the need for any type of locking mechanism, door or other securing devices that increase the cost and complexity of the closed cell washers, e.g., washers 10 and 50.

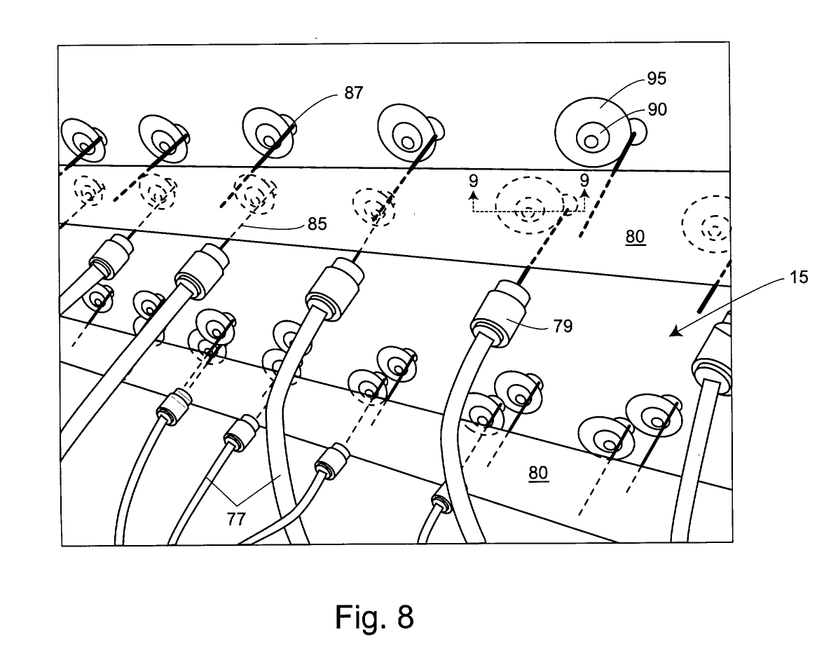

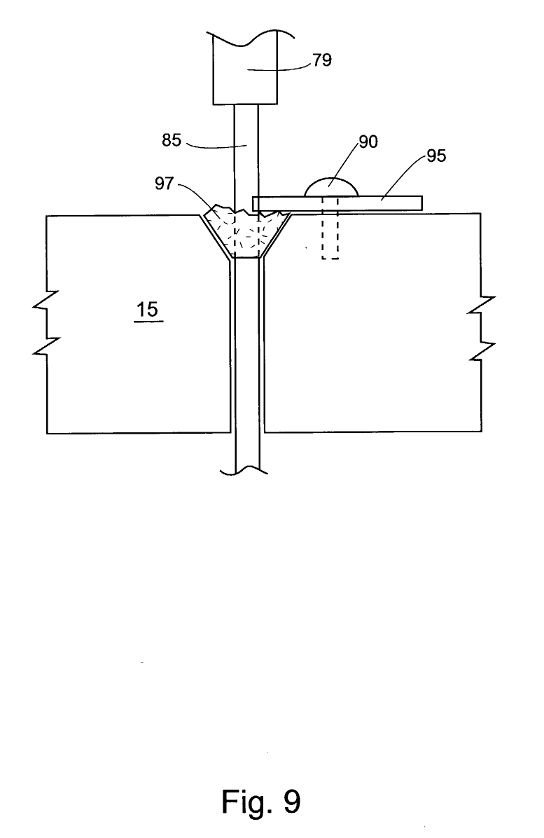

Referring to FIGS. 8 and 9, the mounting mechanism for mounting inlet tube 85 and waste tube 87 to cartridge plate 15 is illustrated. Preferably, inlet tube 85 and waste tube 87 are fine-gauge needles with one or more small diameter openings, or orifices. These small openings can be susceptible to clogging, e.g., from salts or other compounds present in the fluids transported therein and, therefore, are typically replaced frequently. Therefore, the present invention provides easy installation and removal of the tubes. In addition, the tubes or needles are side-ported in some embodiments. In other words, the opening in the needle is on the side of the needle instead of the end. The side opening reduces clogging of the needle by eliminating the tendency of end-ported needles to core into the septa.

For example, inlet tube 85 and waste tube 87, e.g., side ported tubes, are mounted to cartridge plate 15 in a manner that facilitates easy installation and removal of tubes 85 and 87. Referring to FIG. 9, inlet tube 85 is inserted into an opening in cartridge plate 15 that is sized to slidingly engage the inlet tube 85. Once inlet tube 85 is inserted into cartridge plate 15, a sealant 97 is placed around the inlet tube 85. Preferably the sealant is an epoxy, but other types of devices such as glues, bushings, gaskets, or other suitable sealing devices are optionally employed. The sealant fixes the location of inlet tube 85 in cartridge plate 15, but other devices that perform the same function are also optionally employed. After the sealant has been placed around inlet tube 85, a washer or thrust plate 95 is placed around the sealant and inlet tube 85. Washer 95 supports the sealant and helps to maintain the position of the inlet tube in the cartridge plate. A fastener is placed over washer 95 and secures the washer against the sealant and the cartridge plate. It will be appreciated that the above-described procedure for locating an inlet tube in a cartridge plate is also optionally employed to position a waste tube, e.g., waste tube 87, in a cartridge plate.

Because of the arrangements of the above-described components, when an inlet tube or waste tube becomes clogged, it is quickly and easily replaced. Generally, the procedure comprises removing fastener 90 and washer 95. Hose connector 79 is removed from the end of the tube, e.g., tube 85 or 87, and the tube is pulled from the cartridge plate. Sealant 97 does not adhere to the cartridge plate and therefore is also removed with the tube.

In a preferred embodiment, sealant 97 is an epoxy sealant and cartridge plate 15 is comprised of TEFLON (TEFLON is a registered trademark of the E.I. duPont de Nemours Company). The surface characteristics of TEFLON allow epoxies and other types of sealants and glues to be applied to it, but the bond strength to the TEFLON is minimal. However, other types of materials and devices can be used for sealant 97 as well as for the cartridge plate 15. For example, cartridge plates are optionally manufactured from plastics, alloys, or metals, and sealants used are optionally in the form of a gasket, or bearing that engages the cartridge plate.

Heating System For Washing Stations

The present invention also provides heating systems for use with the washing stations provided above. For example, the heating system takes fluid delivered at room temperature and raises it to a pre-determined temperature before it is delivered into the cartridges. The temperature of the chip interface inside the cartridges is also preferably maintained at this temperature as the fluid is pumped into and out of the cartridges. Cartridges are typically made from poorly conducting polymer so that it is difficult to pump heat into the cartridge using conduction. In addition, the back of the glass chip is exposed to the outside on the front of a cartridge. A heat conducting element placed here would prevent the operator from viewing the liquid inside in the cartridge. This is typically undesirable. The present invention provides a highly efficient liquid heat exchanger that is optionally used to control the temperature of the fluid entering the cartridges and the temperature of the air surrounding the cartridges. This eliminates any changes in the temperature across the back of the actual chip and the rest of the cartridge during the wash process. The whole cartridge typically comes to equilibrium at the desired temperature after about 1 or 2 fills.

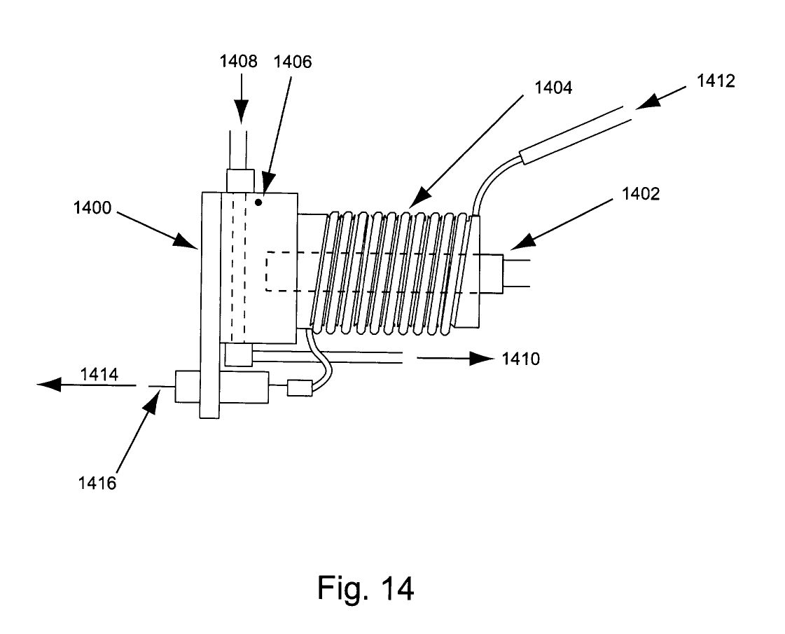

A liquid heat exchanger sub-assembly is illustrated in FIG. 14. The main body of the heat exchanger typically comprises a cylindrical piece of copper or aluminum, e.g., body structure 1400, e.g., with a helical groove cut into the outside and a hole bored into the inside. The internal bore houses an electrical heating element, e.g., element 1402. The helical groove is designed to make intimate contact with a coil of stainless steel tubing, e.g., coil 1404. The coil of stainless steel tubing is typically made by forming it around a mandrel that is smaller in diameter than the helical groove on the heat exchanger. The resulting coil is then threaded onto the grooves of the cylindrical heat sink. The steel tubing is now under radial stress which keeps the tubing in intimate contact with the mating grooves. No other retaining system is required for the tubing, which tubing is coupled to fluid inlet 1412 and fluid outlet 1414 as illustrated.

A plate of heat conducting metal is fastened to the bottom of the cylinder with a heat conducting grease. A small cylinder is soldered onto the plate on an axis offset from the axis of the larger heat sink cylinder. A small precision hole is machined inside of the small cylinder so that the cannula, e.g., cannula 1416, that delivers the fluid can fit inside this hole and have good contact with the cylinder. The cannulas are optionally retained using a set screw. The cannula is now thermally coupled to the larger heat sink cylinder and acts as a secondary heat exchanger system to ensure that the fluid is at the temperature of the heat sink system as close to the delivery point as possible.

A temperature sensor, e.g., sensor 1406, is attached to the main body of the heat exchanger, e.g., body structure 1400. An adaptive closed loop control system is typically used to drive the heating element based on the temperature feedback from the sensor and a desired control temperature. If the control temperature is changed to a lower temperature than what the system has already equilibrated to, the temperature controller turns off the heating element and energizes a solenoid valve to let cooling water flow through the main body of the heat exchanger, e.g., using cooling inlet 1408 and outlet 1410, to quickly bring the temperature down. Once the temperature has dropped an appropriate amount, the solenoid valve is de-energized and the heating element begins its closed loop operation again. The optimal temperature at which the solenoid valve is de-energized is determined by the rate at which the temperature is dropping when the cooling water is turned on and by empirical data which is obtained to determined the temperature sensor lag time.

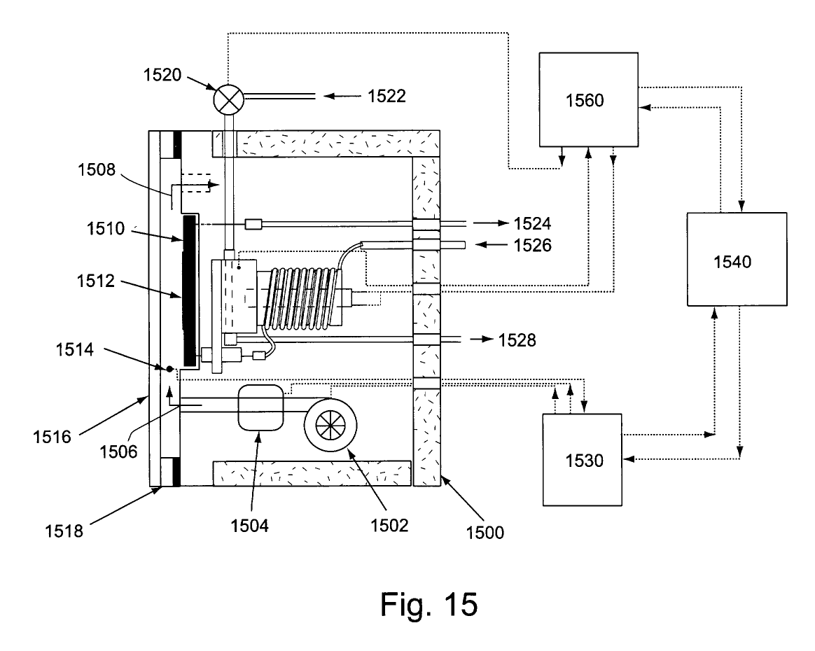

While the above described device controls the fluid temperature used to wash the cartridges, the system described below provides for control of the air temperature. This system typically comprises a blower, heating coils, and a temperature sensor, e.g., sensor 1514 as illustrated in FIG. 15. The blower, e.g., blower 1502, blows air across a set of heating coils, e.g., heating coils 1504, and through holes in the front mounting board so that the heated air flows across the front of the cartridges and then back into an insulated heat exchanger enclosure, e.g., insulated box 1500. Arrows 1506 and 1508 show a typical flow path. The heating coils are typically powered by a closed loop control system that controls the heating coils based on the temperature sensor feedback and the desired control temperature. The blower typically runs continuously to ensure uniform air temperature within the system.

A typical system, e.g., as shown in FIG. 15, comprises cartridge 1510 containing plate 1512. The system is enclosed in insulated box 1500 with clear plastic or glass plate 1516 over the mounting plate, e.g., including door 1518 for opening the enclosure. Air temperature controller 1530 controls the air control system and heat sink temperature controller 1560 controls the liquid temperature to provide efficient temperature control during washing. These are typically coupled to system controller 1540 to provide a fully integrated system. FIG. 15 also illustrates cooling water inlet 1522 and outlet 1528 along with wash fluid inlet and outlets 1526 and 1524.

A main control algorithm is used to take a desired temperature input from an operator and to subsequently set temperatures for the heat sink system, air temperature control system, and to control the state of the cooling water solenoid valve, e.g., valve 1520. Empirical data is optionally obtained to determine temperature set points based on a desired cartridge/fluid temperature and the current temperatures. For instance it is sometimes desirable to run the air temperature higher than the desired set point during a warm-up condition so the cartridge temperature rise rate can be increased. The air temperature is then reduced to its set point based on the heat sink temperature. The steady-state heat sink and air temperatures are optionally independently set to ensure that the desired fluid and cartridge temperatures are maintained.

II. Method of Washing Closed Cell Cartridges

The washing stations described above offer a convenient, robust, high throughput method of washing closed cell cartridges, e.g., cartridges with an enclosed volume. Typically, the methods comprise providing a washing station, e.g., a washing station comprising a cartridge holder with mounting tubes structured to retain the cartridges to be washed in the holder. Typically, this washing station is one that does not rely on a door or movable mounting mechanism to secure the cartridges in the device.

The cartridges are then positioned within the device, e.g., by simply pushing them into a cavity on the cartridge holder, e.g., without the use of a movable mounting mechanism. This is made easy by the inclusion of indentations or reliefs in the cartridge holder cavity that guide placement of the cartridge in the device. The cartridge holders typically contain 1 to about 32 cavities structured to contain a cartridge, although this number is variable.

When the number of cartridges does not match the number of cavities on the device, a non-experimental cartridge, e.g., used as place holder, is typically placed in the cavity to ensure that equivalent wash conditions are maintained across all the cartridges. A “non-experimental cartridge” is one that is not presently being used in an experiment. For example, when the cartridges enclose a biological chip, a non-experimental cartridge could be one that was not used in an experiment, e.g., to detect hybridization of nucleic acids in a sample to oligonucleotides that are attached to the biological chip. The non-experimental cartridges are optionally those that have never been used in an experiment, or that have previously been used in other experiments, but are not being used in the experiment presently being conducted. The invention therefore also provides washing stations in which at least one of the cartridge holders is holding a non-experimental cartridge. This allows one to use a washing station to process a smaller number of cartridges than there are cartridge holders on the washing station. This provides greater flexibility, as it is not necessary to process a full complement of cartridges at once.

Once the cartridges, e.g., experimental or experimental combined with non-experimental place holders, are placed onto the cartridge holder, the device is ready for use. Typically, if any fluid or gas is present in the cartridges, it is removed or purged. The wash fluid is then flowed through the cartridges. The wash material, e.g., a fluid, is then removed and a second wash material flowed into the cartridges, thus washing the cartridges in a cyclic manner. The number of cycles, e.g., wash and purge, the cycle length, purge volume and the buffer reagent selection are typically input by an operator, e.g., using the operator interface as described below, and can be optimized for different size cartridges, e.g., cartridges having different enclosed volumes, for different materials, and the like.

The operator interface is used to modify any internal settings and to input any operator controlled settings. For example, prime time, initial purge time, fast fill time, fast drain time, slow fill time, slow drain time and purge time are all internal settings that can be modified if desired, but do not have to be input for each use of the station. The prime time specifies the duration of a priming cycles, e.g., in seconds. The length of the tubing typically affects this time. The initial purge time specifies an amount of time that fluid is flushed through the devices prior to a washing cycle. This may be skipped entirely if desired. The fast fill time/drain time is the amount of time fluid is pumped into or out of the devices during a wash cycle (in all wash cycles except the last cycle). Typically, the fill time and drain time are the same. Nominal values for the fast fill time and fast drain time are about 7.5 seconds, e.g., for a large or small Affymax chip. The slow fill/drain time is typically used for the last wash cycle and is slower than the prior washes. This time is selected to decrease the amount of bubbles in the cartridges. The slow fill time/drain time is about 12.0 seconds for a large chip and about 2.4 seconds for a small chip. The pump speed for the fast times is about 30 to about 80 rpm and about 10 to about 50 rpm for the slow times. The purge time is the amount of time that fluid is pumped through the devices between groups of wash cycles. The purge time is typically greater than the fill time to remove all “dirty” or used buffer from the cartridges before the next wash cycle, e.g., when a series of different buffers is used.

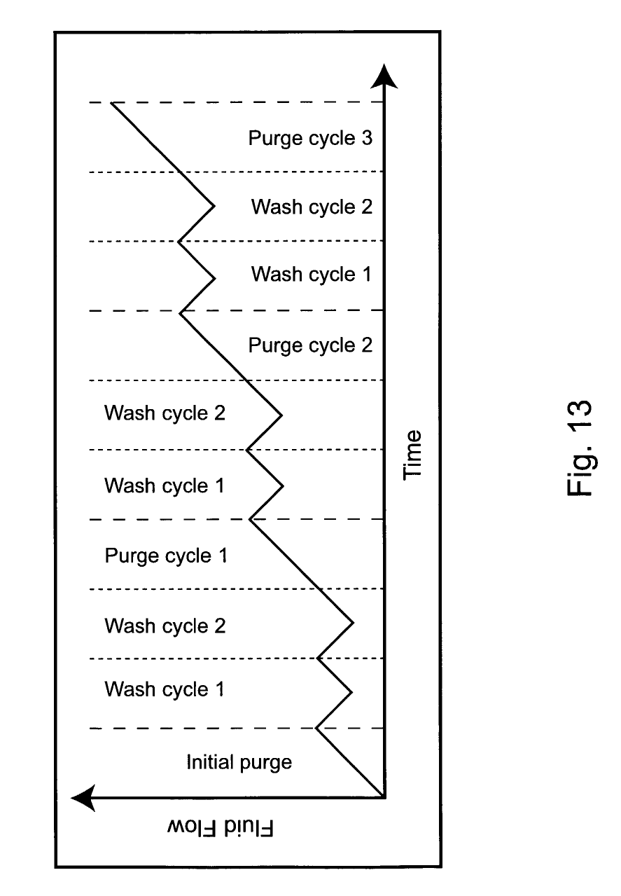

The above parameters are optionally altered but do not need to be input prior to each use of the washing stations. The operator is typically prompted to specify whether a prime cycle is desired, e.g., to prime the system prior to use with a specific buffer, and then prompted to insert the devices to be washed after the prime cycle. After loading of devices, e.g., experimental and/or non-experimental, the operator is prompted for two parameters, typically, the number of purge cycles and the number of wash cycles per purge cycle. A wash cycle is one drain and one fill and a purge cycle replaces the fluid that was used for the washing with a fresh fluid. An example washing sequence is illustrated in FIG. 13. The example sequence comprises an initial purge, and two wash cycles per purge cycle for a total of 6 wash cycles and 3 purge cycles, wherein the last two wash cycles are performed at a lower flow rate.

In the present invention, the washing station is programmable in the sense that the settings are optionally tuned to accommodate a wide range of device volumes. For example, control of fluid delivery provides a system in which both fill flow rate and the fill time are optionally controlled. This allows complete flexibility to control both the volume delivered, e.g., to accommodate different cartridge volumes, and the velocity of the fluid, e.g., to optimize washing.

It will be appreciated that the types of fluid that can be employed in the washing stations of the invention, e.g., either closed cell cartridge washer 10 or bench-top cartridge washer 50, are virtually unlimited. For example, buffers, reagents, solvents, dissolved salt fluids, de-ionized water, other types of water, detergents and anti-bacterial solutions are all optionally employed in the embodiments disclosed herein. Different types of tubing are optionally used to accommodate a large range of fluids, e.g., solvents, buffers, and the like.

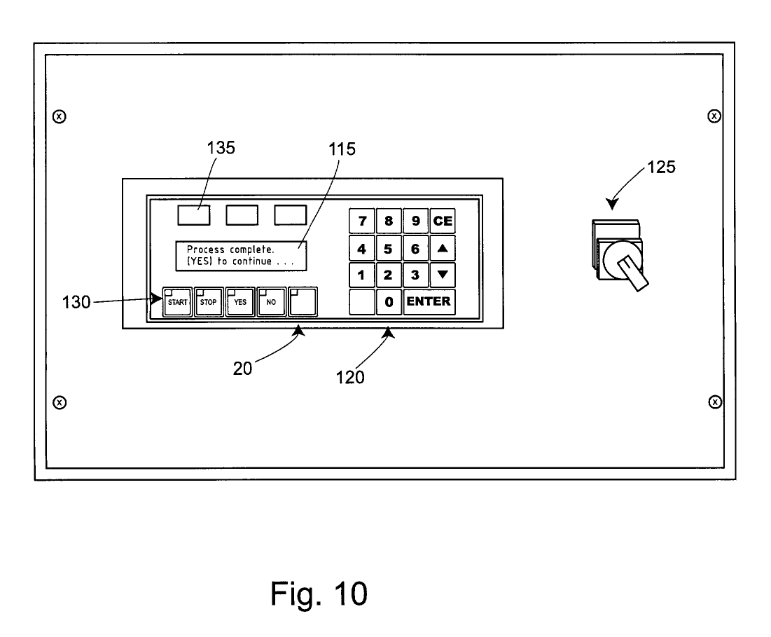

Typically, the wash cycle is set up by an operator using an operator interface, e.g., as provided in FIG. 10 by operator interface 20. A typical operator interface includes, but is not limited to, a graphical display and one or more buttons. For example, operator interface 20 includes display 115, numeric keypad 120, on-off switch 125, a cluster of function keys 130 and warning lamp 135.

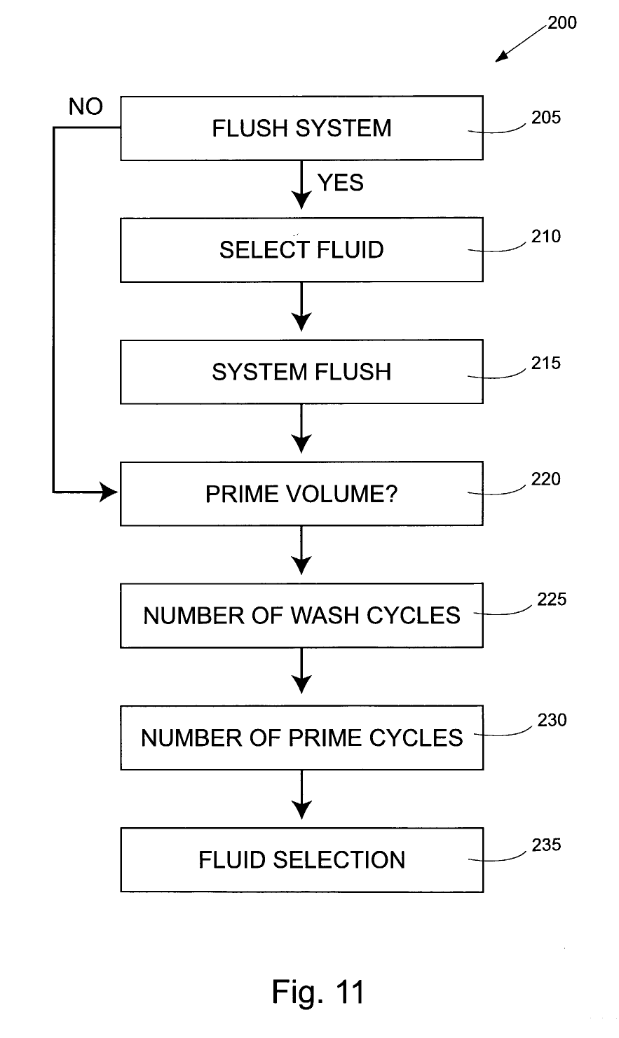

Referring to FIG. 11, the operation of closed cell cartridge washer 10 and bench-top cartridge washer 50 will now be described with reference to flow chart 200. After activating controller 40 by turning on-off switch 125 to the ON position, display 115 asks the operator in step 205 if a system flush is desired. If a system flush is selected, display 115 then asks the operator in step 210 to select a fluid. As discussed above, a wide variety of fluids is optionally employed in cartridge washers 10 and 50. In step 215, the system is flushed. For example, if the operator desires to purge manifold 65, upstream hoses 75, downstream hoses 77, inlet tubes 85 and waste tubes 87 of any unwanted types of fluids, de-ionized or plain water can be selected in the fluid selection step 210 and water will be pumped from pipe 37 through filter 84, into the fluid manifold 65 and through upstream hoses 75 and downstream hoses 77 to inlet tube 85. The water is then ejected from inlet tube 85 and may be captured by a catch basin. Alternatively, dummy closed cell cartridges are optionally placed in the cartridge cavities to receive the fluid. The fluid then fills enclosed volume 112 in the dummy closed cell cartridge and then exits enclosed volume 112 through waste tube 87 which then ejects the fluid into a waste dump, e.g., waste dump 80. For example, waste pipe 82 is connected to waste dump 80, which deposits the waste fluid in an appropriate receptacle.

In step 220, after the system has been flushed or if a system flush was not chosen by the operator, display 115 prompts the operator for a prime volume. The prime volume is generally equivalent to enclosed volume 112 of a single closed cell cartridge. The present invention is capable of washing a variety of closed cell cartridges that have different enclosed volumes. Generally, each closed cell cartridge has an enclosed volume of about two milliliters. Of course, such volume is optionally variable and volumes can comprise, e.g., from less than about 0.5 milliliters to about 5 milliliters or more. Alternatively, the operator is prompted for a flow time instead of an actual volume. However, the time and volume are proportional according to the flow rate which is also optionally modified by the operator.

After entering the prime volume, e.g., through numeric keypad 120, the operator is then prompted, e.g., through display 115, in step 225 for a number of wash cycles. For example, when closed cell cartridge 110 contains un-hybridized material that must be removed, five wash cycles are typically performed. The number of wash cycles typically varies, e.g., depending upon the specimen, e.g., biological or chemical, present in the closed cell cartridge. Generally, a wash cycle includes the steps of draining enclosed volume 112 in closed cell cartridge 110 and filling enclosed volume 112, e.g., with the same fluid that was drained. For example, in the first step of a wash cycle, pump 55 optionally runs backwards, thereby drawing fluid from enclosed volume 112 through inlet tube 85 back down downstream hose 77 towards pump channel 60. Simultaneously, air is drawn into waste tube 87, thereby filling enclosed volume 112 with air. Pump 55 is then reversed, e.g., by controller 40, and fluid, e.g., the same fluid is then pumped through downstream hose 77 into inlet tube 85 and into enclosed volume 112. Once pump 55 has pumped the same amount of fluid into the enclosed volume 112 that was drained, a complete wash cycle has been performed.

One aspect of the present invention is that controller 40 is programmed to know or predict when the last wash cycle will be performed on enclosed volume 112. When the last wash cycle is performed, the fluid flow rate during the filling of enclosed volume 112 is approximately 2.5 milliliters per minute. It has been determined that a fluid fill rate of about 2.5 milliliters per minute avoids formation of bubbles in the enclosed volume. When closed cell cartridges are imaged, bubbles interfere with the imaging process and thus are detrimental to the imaging process. Therefore, the flow rate is typically optimized to minimize bubble formation. The final fill rate of approximately 2.5 milliliters per minute is substantially less than the nominal washing flow rate of 6.8 milliliters per minute. It will be appreciated that other final fill rates and nominal slow rates are optionally employed in the washing stations of the invention, e.g., closed cell cartridge washers 10 and 50 depending upon the volume of the enclosed volume and whether or not the closed cell cartridge will be imaged after the washing process.

In step 230, display 115 asks the operator for a number of prime cycles. A prime cycle is performed by flushing fresh fluid through the enclosed volume of a closed cell cartridge, e.g., enclosed volume 112. Controller 40 has typically been instructed in step 220 as to the prime volume for the closed cell cartridge that is being flushed and instructs pump 55 to pump fresh fluid through inlet tube 85, which fills the enclosed volume and flushes any fluid present in the enclosed volume out waste tube 87 into waste pipe 82. Preferably, pump 55 pumps approximately two prime volumes worth of fluid. For example, if a closed cell cartridge has an enclosed volume of two milliliters, the prime cycle would pump approximately four milliliters of fluid through the enclosed volume. Other prime cycle volumes are optionally pumped through the enclosed volume. For example, three, four or five prime volumes are optionally flushed through the enclosed volume.

In step 235, display 115 asks the operator to select a fluid. Preferably, closed cell cartridge washer 10 and bench-top cartridge washer 50 can access at least two fluids through fluid inlet pipe 37. As shown in FIG. 4, fluid reservoirs, e.g., reservoirs 72, are connected to a fluid selection switch, e.g., switch 74, that is in communication with a controller, such as controller 40. Controller 40 selects an appropriate fluid and pump 55 draws the fluid, e.g., through fluid filter 84. Fluid filter 84, for example, captures all contaminants larger than a desired threshold. For example, in some embodiments the fluid filter captures all contaminants larger than about 150 microns. The fluid then progresses through pipe 37 into fluid inlet 70 and passes into fluid manifold 65. Air bleed valves 67 are located on the upper surface of the fluid manifold 65 and are optionally opened by an operator to release any air bubbles that are present, e.g., in manifold 65. Trapped air bubbles can be compressed during fluid pumping operations, thereby affecting the accuracy of the fluid volumes delivered to the enclosed volumes. By removing air bubbles that may be present in fluid manifold 65, the accuracy of the prime volume and the volumes pumped during wash and prime cycles are maintained.

After selecting the fluid, the operator then pushes the “start-function key,” e.g., located on function keypad 130. Controller 40 then begins the process, e.g., of washing enclosed volumes 112 in closed cell cartridges 110 located in cartridge cavities 100 according to the inputs received from the operator.

Thus, it is seen that an apparatus and method for washing biological specimens, such as closed cell devices, is provided. One skilled in the art will appreciate that the present invention can be practiced by other than the preferred embodiments, which are presented in this description for purposes of illustration and not of limitation, and the present invention is limited only by the claims that follow. For example, features of the devices and methods disclosed in U.S. Pat. No. 6,114,122, issued Sep. 5, 2000, can be included in the devices and methods of the present invention. It is noted that equivalents for the particular embodiments discussed in this description may practice the invention as well.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including any drawings or figures, are hereby incorporated by reference for all purposes.

What is claimed is:

1. A washing station for a cartridge, the washing station comprising:
at least one cartridge holder comprising at least two cartridge mounting tubes, wherein:
a) the cartridge mounting tubes include a first cartridge mounting tube and a second cartridge mounting tube and are structured to retain the cartridge in the cartridge holder; and
b) the cartridge holder is not associated with a door; and
at least one fluid source communicating with at least one of the cartridge mounting tubes.

2. The washing station of claim 1, wherein the cartridge holder is not associated with a movable mounting system.

3. The washing station of claim 1, further comprising a controller that controls delivery of fluid from the fluid source to the first cartridge mounting tube.

4. The washing station of claim 1, wherein the second cartridge mounting tube communicates with a waste dump.

5. The washing station of claim 1, wherein the washing station comprises from 1 to 32 cartridge holders.

6. The washing station of claim 1, wherein the washing station comprises two or more cartridge holders, at least one of which holds a non-experimental cartridge, thereby allowing washing of fewer experimental cartridges than the number of cartridge holders on the washing station.

7. The washing station of claim 1, wherein the cartridge mounting tubes frictionally engage at least two tube receiving elements located on the cartridge.

8. The washing station of claim 7, wherein the tube receiving elements are selected from the group consisting of: septa, o-rings, diaphragms, and membranes.

9. The washing station of claim 1, wherein the fluid source comprises at least two reservoirs.

10. The washing station of claim 1, wherein the fluid source contains at least one fluid selected from the group consisting of: buffers, solvents, reagents, dissolved salts, de-ionized water, water, detergents, and antibacterial solutions.

11. The washing station of claim 1, further including a fluid pump communicating with the fluid source.

12. The washing station of claim 11, wherein the fluid pump has a fluid flow rate that ranges from about 2 milliliters per minute to about 7 milliliters per minute.

13. The washing station of claim 11, wherein the fluid pump is selected from the group consisting of: peristaltic pumps, syringe pumps, multi-channel pumps, multi-channel peristaltic pumps, and multi-channel syringe pumps.

14. The washing station of claim 1, further including a fluid selection valve coupled to the fluid source and communicating with a controller.

15. The washing station of claim 1, further including a fluid filter communicating with the fluid source.

16. The washing station of claim 15, wherein the fluid filter captures all objects larger than 150 microns.

17. The washing station of claim 1, further including a fluid level sensor coupled to the fluid source and communicating with a controller.

18. The washing station of claim 17, wherein the fluid level sensor detects a fluid level in the fluid source.

19. The washing station of claim 1, wherein each cartridge mounting tube is coupled to the cartridge holder by a single fastener.

20. The washing station of claim 1, wherein the cartridge is structured to enclose a specific volume of gas or fluid.

21. The washing station of claim 1, wherein the cartridge comprises a biological chip.

22. The washing station of claim 1, wherein the cartridge holder comprises two indentations arranged to permit removal and mounting of the cartridge by grasping the cartridge by a top and bottom surface.

23. The washing station of claim 1, further comprising a controller.

24. The washing station of claim 23, wherein the controller is a microprocessor.

25. The washing station of claim 1, further including a fluid manifold located between the fluid source and the cartridge mounting tubes.

26. The washing station of claim 25, further including at least one air bleed valve coupled to the fluid manifold.

27. The washing station of claim 1, further including a flow monitor or pressure monitor.

28. The washing station of claim 1, further including a heating system.

29. A method of washing an enclosed volume located within a cartridge, the method comprising:
providing a washing station comprising at least one cartridge holder that comprises at least two cartridge mounting tubes structured to retain the cartridge on the washing station, wherein the cartridge holder is not associated with a door;
positioning the cartridge on the cartridge mounting tubes;
removing a fluid from the enclosed volume, if the enclosed volume initially contains a fluid; and
introducing a wash fluid into the enclosed volume.

30. The method of claim 29, wherein the cartridge holder is not associated with a movable mounting system.

31. The method of claim 29, wherein the wash fluid comprises fluid that was removed from an enclosed volume of a cartridge.

32. The method of claim 29, wherein fluid is removed and introduced into the enclosed volume in a cyclic manner.

33. The method of claim 32, wherein the wash fluid is introduced into the enclosed volume at least three times.

34. The method of claim 29, wherein the fluid is removed by introducing a wash fluid into the enclosed volume so that a majority of the first fluid is removed from the enclosed volume.

35. The method of claim 29, wherein the washing station comprises a plurality of cartridge washing tubes communicating with a plurality of enclosed volumes, with each cartridge washing tube coupled to a pump channel so that an amount of fluid removed and introduced into each enclosed volume is substantially identical.

36. The method of claim 29, wherein the method further comprises attaching a non-experimental cartridge to each cartridge holder which is not occupied by an experimental cartridge.

37. The method of claim 29, further comprising the step of re-introducing the fluid into the enclosed volume so that no bubbles form in the enclosed volume.

38. The method of claim 29, wherein the wash fluid is introduced into the enclosed volume at rate of between 2 milliliters per minute to 7 milliliters per minute.

39. A washing station for washing a plurality of cartridges, comprising:
a plurality of cartridge holders, each cartridge holder comprising at least two cartridge mounting tubes that are structured to retain a cartridge in a cartridge holder, wherein the cartridge holders are not associated with a door;
at least one fluid source coupled to a pump;
a fluid manifold coupled to the pump, the fluid manifold structured to distribute a fluid received from the pump to a plurality of hoses, each hose coupled to a cartridge mounting tube; and
a controller communicating with the pump, the controller structured to control a rate of fluid delivery to at least half of the cartridge mounting tubes.

40. The washing station of claim 39, wherein at least one cartridge mounting tube in each cartridge holder is a waste tube communicating with a fluid waste dump.

41. The washing station of claim 39, wherein the cartridge mounting tubes frictionally engage at least two tube receiving elements located on each cartridge.

42. The washing station of claim 39, further including a fluid selection valve communicating with the controller.

43. The washing station of claim 39, wherein the pump has a fluid flow rate that ranges from about 2 milliliters per minute to about 7 milliliters per minute.

44. The washing station of claim 39, wherein the pump is selected from the group consisting of: peristaltic pumps, syringe pumps, multi-channel pumps, multi-channel peristaltic pumps, and multi-channel syringe pumps.

45. A cartridge plate comprising at least one substantially open closed cell holder that is not associated with a door.

46. The cartridge plate of claim 45, wherein the closed cell holder comprises at least two closed cell mounting tubes, wherein the closed cell mounting tubes are coupled to the closed cell holder by a single fastener.

47. A washing station for a cartridge, the washing station comprising:
at least one cartridge holder comprising at least two cartridge mounting tubes, wherein:
a) the cartridge mounting tubes include a first cartridge mounting tube and a second cartridge mounting tube and are structured to retain the cartridge in the cartridge holder; and
b) the cartridge holder is not associated with a movable mounting system; and
at least one fluid source communicating with at least one of the cartridge mounting tubes.

48. The washing station of claim 47, wherein the cartridge holder is not associated with a door.

49. The washing station of claim 47, further comprising a controller that controls delivery of fluid from the fluid source to the first cartridge mounting tube.

50. The washing station of claim 47, wherein the second cartridge mounting tube communicates with a waste dump.

51. The washing station of claim 47, wherein the washing station comprises from 1 to 32 cartridge holders.

52. The washing station of claim 47, wherein the washing station comprises two or more cartridge holders, at least one of which holds a non-experimental cartridge, thereby allowing washing of fewer experimental cartridges than the number of cartridge holders on the washing station.

53. The washing station of claim 47, wherein the cartridge mounting tubes frictionally engage at least two tube receiving elements located on the cartridge.

54. The washing station of claim 53, wherein the tube receiving elements are selected from the group consisting of: septa, o-rings, diaphragms, and membranes.

55. A method of washing an enclosed volume located within a cartridge, the method comprising:
providing a washing station comprising at least one cartridge holder that comprises at least two cartridge mounting tubes structured to retain the cartridge on the washing station, wherein the cartridge holder is not associated with a movable mounting system;
positioning the cartridge on the cartridge mounting tubes;
removing a fluid from the enclosed volume, if the enclosed volume initially contains a fluid; and
introducing a wash fluid into the enclosed volume.

56. The method of claim 55, wherein the cartridge holder is not associated with a door.
